(19) United States
(12) Patent Application Publication
(10) Pub. No.: US 2018/0210435 A1
(43) Pub. Date: Jul. 26, 2018

(54) Method and Device for Optimizing Solid Phase Transport in Pipe Flow

(71) Applicant: Halliburton Energy Services, Inc., Houston, TX (US)

(72) Inventors: Feifei Zhang, Houston, TX (US); Andrey Filippov, Houston, TX (US); Jianxin Lu, Bellaire, TX (US)

(73) Assignee: Halliburton Energy Services, Inc., Houston, TX (US)

(21) Appl. No.: 15/545,075

(22) PCT Filed: May 13, 2016
(86) PCT No.: PCT/US2016/032497

§ 371 Date: Jul. 20, 2017

(51) Int. Cl. G05B 19/44; B65G 53/66; B65G 53/10; G06F 17/50; B08B 9/043

(52) U.S. Cl. CPC G05B 19/44; B65G 53/66; B65G 53/10; G06F 2217/34; B08B 9/0433; G06F 2217/16; G06F 17/5022

(57) ABSTRACT

A computing system includes a processor that estimates a pattern of a flow of a mixture of particles and a fluid in a tubular structure as a stationary bed flow, a dispersed flow, or a transitional flow that is relative to the stationary bed and dispersed flows. The processor estimates a plurality of parameters based on the estimated pattern. The processor determines a plurality of dimensionless parameters, based on the estimated parameters. The dimensionless parameters include a first dimensionless parameter corresponding to an effect of turbulence on the flow and a second dimensionless parameter corresponding to an effect of gravity on the flow. The processor characterizes the pattern of the flow as the stationary bed flow, the dispersed flow, or the transitional flow, based on the dimensionless parameters. The processor models the flow based on the estimated pattern if it is determined that the characterized pattern matches the estimated pattern.

### BACKGROUND

A flow within a flow conduit (e.g., a tubular structure such as a pipe) may include multiple phases. In various industries such as mining, civil, and oil and gas, the phases include a liquid phase and a particle phase. During operation, various characteristics and/or parameters corresponding to the flow may be monitored. These parameters may include a pattern of the flow, a concentration of particles in the flow, and/or a degree of particle deposition in the flow.

A sufficiently high particle concentration and/or a sufficiently high degree of particle deposition in the conduit could lead to a significant loss in pressure and/or a blockage in the conduit. As a result, system damage, accidents, and/or other mishaps may occur.

### BRIEF DESCRIPTION OF THE DRAWINGS

There are disclosed in the drawings and the following description methods and systems employing parameters (e.g., dimensionless parameters) for determining characteristics of a flow. In the drawings:

FIGS. 1(a), 1(b), 1(c), 1(d) and 1(e) illustrate examples of flow patterns of a two-phase flow;

FIG. 2 illustrates an example of an orientation of a flow direction with respect to a direction of gravity;

FIG. 3 illustrates an example of a flow pattern mapping;

FIG. 4 illustrates an example of a flowchart for modeling a flow;

FIG. 5 depicts an illustrative flow scenario;

FIG. 6 is a flowchart showing an illustrative determination method; and

FIG. 7 is a simplified block diagram of a computer system adapted for implementing a flow modeling system.

It should be understood, however, that the specific embodiments given in the drawings and detailed description do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are methods and systems for determining characteristics of a flow of mixture of particles and fluid in a tubular structure. According to at least some embodiments, a method includes estimating a pattern of the flow as a stationary bed flow, a dispersed flow, or a transitional flow that is relative to the stationary bed flow and the dispersed flow. The method further includes estimating a plurality of parameters based on the estimated pattern of the flow. The method further includes determining a plurality of dimensionless parameters, based on the estimated plurality of parameters. The dimensionless parameters include a first dimensionless parameter corresponding to an effect of turbulence on the flow and a second dimensionless parameter corresponding to an effect of gravity on the flow. The method further includes characterizing the pattern of the flow as the stationary bed flow, the dispersed flow, or the transitional flow, based on the determined plurality of dimensionless parameters, and modeling the flow based on the estimated pattern if it is determined that the characterized pattern matches the estimated pattern.

A related computing system includes a processor that estimates a pattern of a flow of a mixture of particles and a fluid in a tubular structure as a stationary bed flow, a dispersed flow, or a transitional flow that is relative to the stationary bed flow and the dispersed flow. The processor estimates a plurality of parameters based on the estimated pattern of the flow. The processor determines a plurality of dimensionless parameters, based on the estimated plurality of parameters. The dimensionless parameters include a first dimensionless parameter corresponding to an effect of turbulence on the flow and a second dimensionless parameter corresponding to an effect of gravity on the flow. The processor characterizes the pattern of the flow as the stationary bed flow, the dispersed flow, or the transitional flow, based on the determined plurality of dimensionless parameters. The processor models the flow based on the estimated pattern if it is determined that the characterized pattern matches the estimated pattern.

Because a sufficiently high particle concentration and/or a sufficiently high degree of particle deposition in a flow conduit could lead to a significant loss in pressure and/or a blockage in the conduit, predictions and estimates of a flow pattern, a pressure gradient, and/or a concentration of particles in the conduit often are estimated during design and/or operation of a flow system.

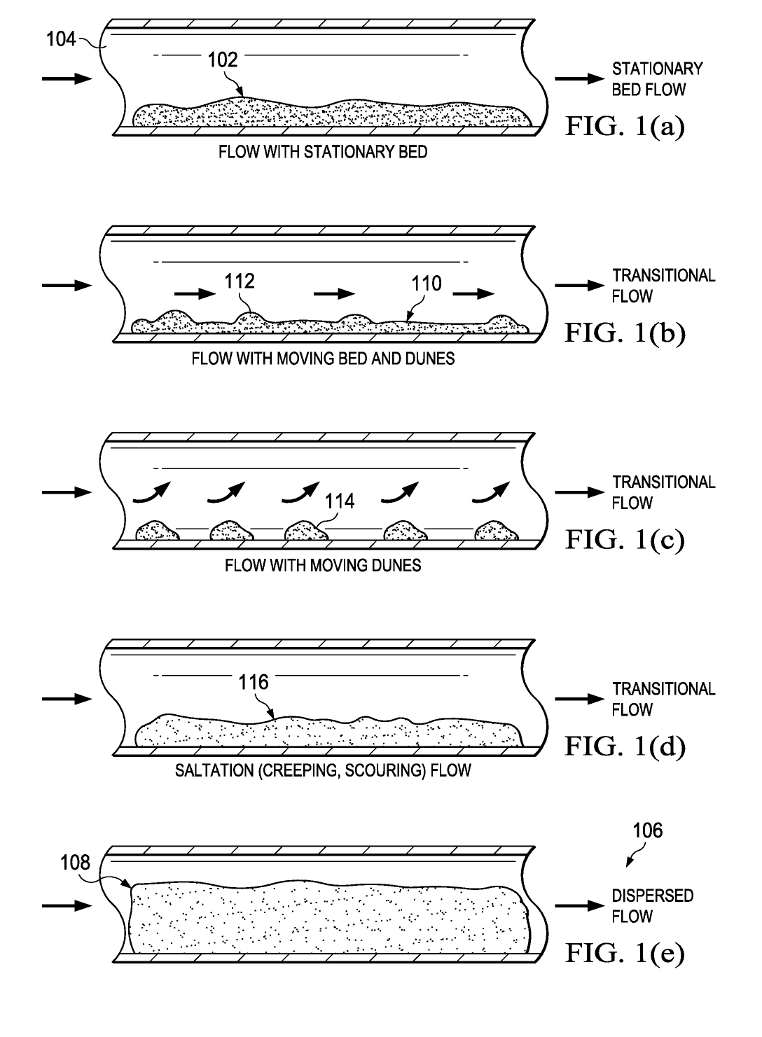

FIGS. 1(a), 1(b), 1(c), 1(d) and 1(e) illustrate examples of flow patterns of a two-phase flow. In a two-phase flow, one phase is a liquid (e.g., water), and another phase may be particles of a solid (e.g., sand particles, glass particles, or glass spheres). The pattern of such a flow may be classified as one of various patterns. For example, the pattern may be classified as either a stationary bed flow, a dispersed flow, or a transitional flow with respect to the stationary bed and dispersed flows.

FIG. 1(a) illustrates an example of a stationary bed flow. In the stationary bed flow, at least a portion of the particle phase forms a bed 102 (e.g., a packed bed) at the bottom of a flow conduit. A flow 104 is located above the bed 102. The flow 104 may include a mixture of liquid(s) and solid(s). Alternatively, the flow 104 may largely include liquid(s) only. The bed 102 is stationary in that the positions of the particles that form the bed are static as the flow 104 moves through the flow conduit.

FIG. 1(e) illustrates an example of a dispersed flow 106. Unlike the flow 104 of FIG. 1(a), the dispersed flow 106 is not located above a packed bed. Rather, the conduit of FIG. 1(e) lacks a bed similar to the bed 102 of FIG. 1(a). Particles 108 in the conduit are fully dispersed in the flow 106 and, therefore, move with the flow. The distribution of the particles 108 may be homogeneous (a single type of particles) or heterogeneous (two or more types of particles).

FIGS. 1(b), 1(c) and 1(d) illustrate examples of a transitional flow. The transitional flow is a transitional pattern that may include similarities with a stationary bed flow (see FIG. 1(a)) as well as similarities with a dispersed flow (see FIG. 1(e)). For example, with reference to FIG. 1(b), at least a portion of a particle phase forms a bed 110 and one or more dunes 112 located at the bottom of a flow conduit. Particles that form the bed 110 and the dunes 112 are not stationary and may move along the direction of the flow.

As another example, with reference to FIG. 1(c), at least a portion of a particle phase forms one or more dunes 114 located at the bottom of a flow conduit. Particles that form the dunes 114 are not stationary and may move along the direction of the flow. As another example, with reference to FIG. 1(d), particles 116 are not packed, but are mostly concentrated at the bottom of the conduit.

In order to predict the pattern(s) of a particular flow, a series of experimental tests may be conducted. Based on such tests, the flow patterns may be plotted or mapped, e.g., by using parameters such as superficial particle velocity and fluid velocity. However, according to such an approach, the breadth of the resulting plots or maps may be somewhat limited. For example, the maps may be valid in situations involving conditions under which the experimental tests were conducted, but not in other situations. For example, the experimental tests may have been conducted assuming monodisperse particles of a specific size. In this regard, the resulting maps may be valid in situations where such particles are present, but not in other situations. For different situations, the size of transported particles may vary significantly (e.g., from tens of microns to several centimeters). Performing experimental tests in order to cover such a range of sizes might not be practical.

Particle size is but one example of a parameter that affects the pattern of a particular flow. Other examples of such parameters include particle shape, bulk density, particle volume fraction in the flow, flow conduit shape and size, flow conduit inclination angle, fluid velocity, and fluid viscosity and density. Similar to particle size, some of these additional parameters are measured based on a particular dimension (or a fundamental unit, e.g., of mass, length, or time). Performing experimental tests in order to cover a suitable range for one or more of these parameters might not be practical.

As noted earlier, estimates of a pressure gradient and a concentration of particles may also be predicted or estimated. Such estimates may be based upon an estimated pattern(s) for a particular flow. Therefore, an improved approach for estimating the pattern(s) of a particular flow may likewise improve the estimation of parameters such as pressure gradient and particle concentration.

According to various embodiments disclosed herein, dimensionless parameters are used to classify patterns of a flow (e.g., a two-phase flow in a pipe). For example, values of the dimensionless parameters are used to classify a particular flow as a stationary bed flow (see, e.g., FIG. 1(a)), a dispersed flow (see, e.g., FIG. 1(e)) or a transitional flow (see, e.g., FIGS. 1(b), 1(c), 1(d)).

The dimensionless parameters may serve as a measure of various factors that affect solid phase transport. According to particular embodiments, the classification may be performed based on a flow pattern map. The flow pattern map may have axes that respectively correspond to a first dimensionless parameter and a second dimensionless parameter. As such, the breadth of the map is more generalized, in that the map is valid for a variety of different particles, different conduits, and/or different fluids,

In addition, the dimensionless parameters are also used to estimate parameters such as a pressure gradient and a particle concentration (or particle volume fraction). The classification of the patterns and/or the determination of such values may be useful in a variety of contexts or scenarios involving solid phase transport in pipe flow. Such contexts include proppant transport during hydraulic fracturing, sand cleaning during hydrocarbon production, and hydraulic transport (e.g., in the mining industry).

According to at least one embodiment, a first dimensionless parameter Ωₕ is determined based on the following equation:

$${Ω}_{h} = \frac{{u}^{*}}{{u}_{settling} \cdot sin θ} . \qquad ( 1 )$$

In the above Equation (1), u* denotes a friction velocity (or sheer velocity) of the flow, u_{settling} denotes a settling velocity (or terminal velocity) of particles in the fluid, and θ denotes an inclination angle of a conduit (e.g., a pipe) deviated from vertical.

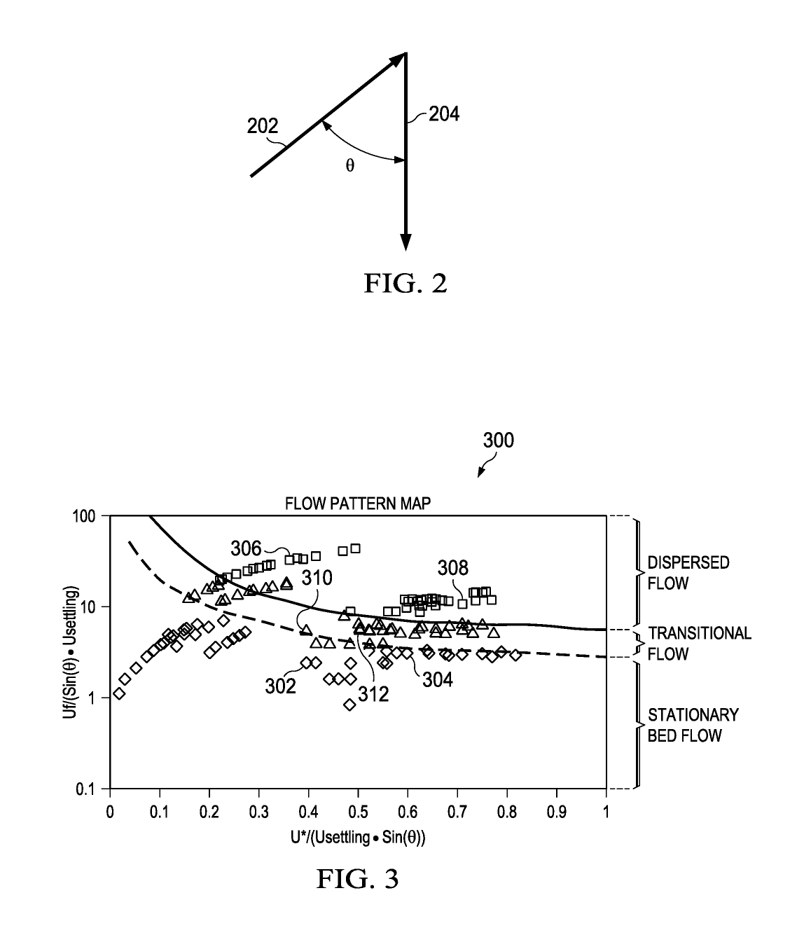

FIG. 2 illustrates an example of a flow direction with respect to a downward direction of gravity. With reference to FIG. 2, a direction 202 corresponds to a direction of flow, and a direction 204 corresponds to a downward direction of gravity.

θ denotes an angle between the direction 202 and the direction 204. θ may range from 0 to 180 degrees. For example, a value of 0 degrees indicates that the flow is in a fully upward direction (e.g., fully opposite the force of gravity). A value between 0 and 90 degrees indicates that the flow is in a partially upward direction. A value between 90 and 180 degrees indicates that the flow is in a partially downward direction, and a value of 180 degrees indicates that the flow is in a fully downward direction (e.g., fully with the force of gravity).

The friction velocity u* is determined based on the following equation:

$${u}^{*} = \sqrt{\frac{τ}{{ρ}_{f}}} . \qquad ( 2 )$$

In the above Equation (2), r denotes the shear stress in an arbitrary layer of fluid (which is related to the pressure gradient) and ρ_{f} denotes the fluid density.

According to at least one embodiment, a second dimensionless parameter Ωᵥ is determined based on the following equation:

$${Ω}_{v} = \frac{{u}_{f}}{{u}_{settling} \cdot sin θ} . \qquad ( 3 )$$

In the above Equation (3), u_{f} denotes the average carrier fluid velocity, which is the fluid volume flow rate divided by the open area of the conduit.

For a particular flow, values of the dimensionless parameters Ωₕ and Ωᵥ are used to classify a particular flow as being one of various patterns. For example, the flow may be classified as either a stationary bed flow, a dispersed flow, or a transitional flow. The classification may be based on a flow pattern map. An example of a flow pattern map is illustrated in FIG. 3.

In the map 300, the horizontal axis (x-axis) represents values of the dimensionless parameter Ωₕ, and the vertical axis (y-axis) represents values of the dimensionless parameter Ωᵤ. Depending on the position of a particular (x, y) pairing in the map 300, a corresponding flow is classified as either a stationary bed flow, a dispersed flow, or a transitional flow.

For example, with continued reference to FIG. 3, pairing 302 would be classified as a stationary bed flow. Similarly, pairing 304 would be classified as a stationary bed flow. Pairing 306 would be classified as a dispersed flow. Similarly, pairing 308 would be classified as a dispersed flow. Pairing 310 would be classified as a transitional flow. Similarly, pairing 312 would be classified as a transitional flow.

The classification illustrated in FIG. 3 is based on parameters that are dimensionless. For example, neither of the parameters Ωₕ and Ωᵥ is measured by or based on a fundamental unit, e.g., of mass, length, or time. Accordingly, the classification is not constrained by experimental test factors, such as the size of solid particles (which, as described earlier, may range from several micrometers to one centimeter).

The values of the dimensionless parameters Ωₕ and Ωᵥ describe various physical effects influencing the solid phase transport. For example, the dimensionless parameter Ωₕ characterizes importance of flow turbulence, resuspending the particles. High values of this parameter indicate that most particles may be expected to be well mixed with the carrier fluid. The dimensionless parameter Ωᵥ characterizes the effect of gravity on the flow. Low values of this parameter indicate that most particles may be expected to be settled at the bottom of the conduit. As expressed in Equations (1) and (3), both Ωₕ and Ωᵥ are determined based, at least in part, on the settling velocity u_{settling} and the angle θ. The settling velocity u_{settling}, multiplied by sin θ is a component of the settling velocity in the direction perpendicular to the conduit axis.

The settling velocity u_{settling} reflects various properties of solid particles (e.g., size, shape, and density). Various fluid properties (e.g., density and viscosity) are reflected in both the settling velocity u_{settling} and the friction velocity u*. The particle concentration and the conduit geometry may also be reflected in the friction velocity. The conduit inclination angle is accounted for by including sin 9 in the determination of flᵤ.

With respect to flows that are classified as stationary bed flows and/or transitional flows, layer models have been described in Wilson, Slip Point of Beds in Solids-liquid Pipeline Flow, Proc. ASME, J. Hyd. Div., 96, 1-12, 1990, and in Doron et al., Flow of Solid-Liquid Mixture in Inclined Pipes. Int. J. Multiphase Flow Vol. 23, No. 2, pp. 313-323, 1997. These layer models effectively describe a balance of mass and momentum in each section (e.g., packed particles, particle-liquid mixture, liquid) in the flow.

According to various embodiments, a flow is modeled based on a convergence between an assumed pattern of the flow and a determined pattern of the flow. Accordingly, a pressure gradient and a particle concentration in the flow are determined. Further, the flow may be modeled based on a balance between a deposition rate and a re-suspension rate of particles

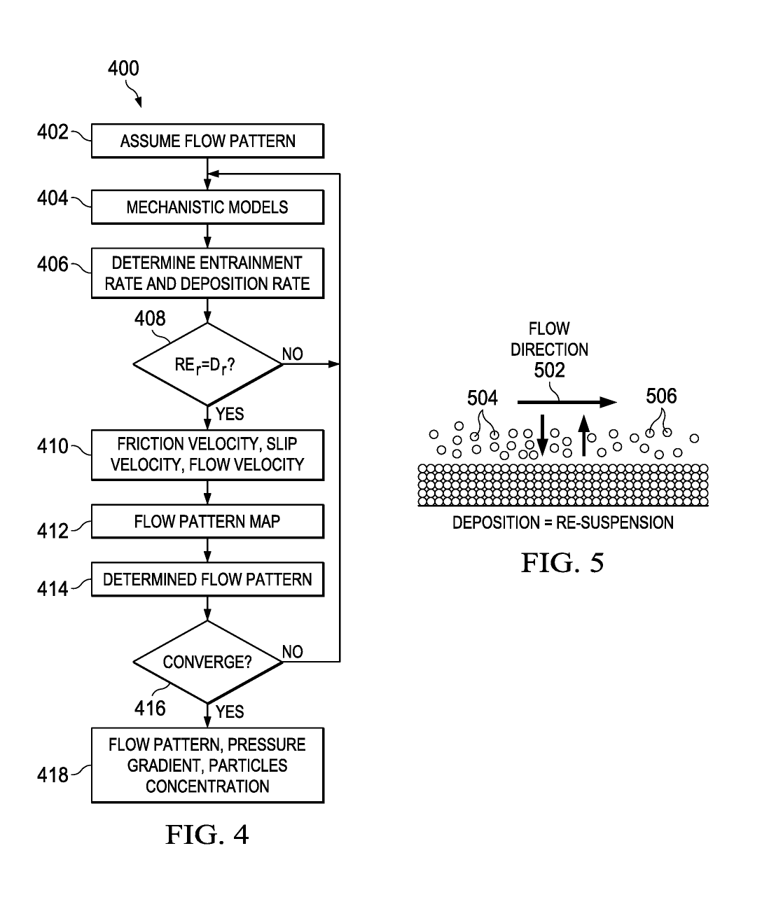

The modeling of the flow may be performed, as illustrated in the flowchart 400 of FIG. 4.

In block 402, a flow pattern of a particular flow is assumed or estimated. For example, the flow is estimated as a stationary bed flow (see, e.g., FIG. 1(a)), a dispersed flow (see, e.g., FIG. 1(e)), or a transitional flow (see, e.g., FIG. 1(b), 1(c), or 1(d)).

In block 404, the layer models, as described in Wilson and Doron et al., are utilized. As noted earlier, the layer models effectively describe a balance of mass and momentum in each section. If the estimated flow is the stationary bed flow or the transitional flow, then a deposition rate Dᵣ and a re-suspension rate REᵣ are determined in block 406.

FIG. 5 depicts an illustrative flow scenario. With reference to FIG. 5, a flow moves along a direction 502. Over a certain period of time, solid particles 504 may be deposited according to a deposition rate. In this regard, the particles 504 are deposited in a flow conduit such that the particles become part of a stationary bed (e.g., stationary bed 102), a moving bed (e.g., bed 110), and/or a moving dune (e.g., dune 112, 114). Also over this period of time, solid particles 506 may be re-suspended in the flow conduit. For example, particles 506 that formed part of a bed (e.g., bed 102, bed 110) or a moving dune are re-suspended in the fluid so that the particles flow with the fluid along the direction 502.

As noted earlier, a flow may be modeled based on a balance between the deposition rate and re-suspension rate (entrainment rate) of particles. According to particular embodiments, the values of dimensionless parameters (e.g., Ωₕ, Ωᵥ) are determined if it is determined that the deposition rate and the re-suspension rate are balanced (e.g., approximately equal to each other).

Formulations for determining the deposition rate are described in Li et al., “Overview Particles Transport Study and Application in Oil-Gas Industry-Theoretical Work”, IPTC 17832, International Petroleum Technology Conference, 10-12 Dec. 2014, Kuala Lumpur, Malaysia.

The deposition rate Dᵣ is determined based on the following equation:

Dᵣ=m_{dep}u_{settling} sin θ. (4)

In Equation (4), m_{dep} denotes the deposition factor, which is a dimensionless number controlling the particle deposition rate. As noted earlier with reference to Equations (1) and (3), u_{settling} denotes the settling velocity, and θ denotes the inclination angle of the conduit deviated from vertical.

The re-suspension rate REᵣ is determined based on the following equations:

$${RE}_{r} = ( \begin{matrix}{m}_{ent} ( {u}^{*} - {U}_{t}^{*} ) & {u}^{*} > {U}_{t}^{*} \\ 0 & {u}^{*} < {U}_{t}^{*}\end{matrix} ) \qquad ( 5 )$$

In Equations (5), mₑₙₜ denotes the entrainment coefficient, which is a dimensionless number controlling the particle deposition rate. As noted earlier with reference to equations (1) and (2), u* denotes the friction velocity. Uₜ* denotes the threshold friction velocity required to lift a solid particle, which depends on fluid properties and particle properties. Further details regarding the threshold friction velocity Uₜ* can be found in Li et al. referenced earlier. If the value of the friction velocity u* is smaller than the threshold friction velocity, then the friction velocity is not sufficiently high to lift (or dislodge) a particle from a bed or a dune. In this situation, no particles are re-suspended, and the re-suspension rate is determined to be zero. However, if the value of the friction velocity u* is larger than the threshold friction velocity, then the friction velocity is sufficiently high to lift (or dislodge) a particle. In this situation, at least some particles are re-suspended, and the re-suspension rate is determined to be proportional to a difference between the friction velocity and the threshold friction velocity.

With reference back to FIG. 4, in block 408, it is determined whether the re-suspension rate REᵣ and the deposition rate Dᵣ are balanced. For example, if it is determined that abs (REᵣ−Dᵣ) is greater than a particular tolerance level, then it may be determined that the re-suspension and deposition rates are not balanced. In this situation, the modeling returns to blocks 402, 404, where the layer models, as described in Wilson and Doron et al., are utilized again. Here, the modeling is performed based on an assumed flow pattern that is different from a previously assumed flow pattern(s). The re-suspension rate REᵣ and the deposition rate Dᵣ are determined again (see block 406), and so forth.

If it is determined that the re-suspension rate REᵣ and the deposition rate Dᵣ are balanced (or if the flow pattern assumed in block 402 is the dispersed flow), then, at block 410, parameters are determined in order to determine the values of the dimensionless parameters (e.g., Ωₙ and Ωᵥ). These parameters include a friction velocity, a slip velocity, and a flow velocity. The slip velocity may be determined by using Stokes' law (as described in more detail, e.g., in Shook et al., Slurry flow: principles and practice, 1991, Reed Publishing). The friction velocity may be calculated using Equation (2) noted earlier, and the flow velocity may be determined by dividing the flow rate by the open area of the fluid flow. The values of the dimensionless parameters Ωₕ and Ωᵥ are then determined using Equations (1) and (3).

In block 412, the determined values of the dimensionless parameters may then be applied to a flow pattern map (e.g., flow pattern map 300). Based on the application of the determined values to the flow pattern map, a corresponding flow pattern is determined in block 414. In block 416, the determined flow pattern is compared against the assumed flow pattern (e.g., of block 402). If the determined flow pattern does not match the assumed flow pattern, then the assumed flow pattern is not used to model the flow. Instead, the modeling returns to blocks 402, 404, where the layer models, as described in Wilson and Doron et al., are utilized again. Here, the modeling is performed based on an assumed flow pattern that is different from a previously assumed flow pattern(s). The re-suspension rate REᵣ and the deposition rate Dᵣ are determined again (see block 406), and so forth.

If the determined flow pattern matches the assumed flow pattern, then the flow is modeled based on the assumed flow pattern (see block 418).

For example, in block 402, a flow may have been assumed to be a stationary bed flow. Based on this assumption, values of dimensionless parameters (e.g., Ωₕ and Ωᵥ) are determined. The values of the dimensionless parameters are then applied to a flow pattern map (e.g., flow pattern map 300) to determine a corresponding flow pattern. If the determined flow pattern is also a stationary bed flow, then the flow is modeled based on the flow being a stationary bed flow. If the determined flow pattern is a transitional flow or a dispersed flow, then the flow is not modeled based on the flow being a stationary bed flow.

With reference back to block 418, the flow is modeled based on the assumed flow pattern. For example, a pressure gradient and a particle concentration in the flow are determined.

If a stationary bed flow or a transitional flow was assumed, the pressure gradient and the particle concentration can be obtained by using the mechanistic models as described by Zhang et al., “Pressure Profile in Annulus: Particles Play a Significant Role”, Journal of Energy Resources Technology, November 2015; 137(6).

If a dispersed flow was assumed, the particle concentration C may be determined based on the following equation:

$$C = - \frac{{U}_{m} - {U}_{slip}}{2 \cdot {U}_{slip}} + {( {( \frac{{U}_{m} - {U}_{slip}}{2 \cdot {U}_{slip}} )}^{2} + \frac{{U}_{ss}}{{U}_{slip}} )}^{0.5} . \qquad ( 6 )$$

In Equation (6), Uₘ denotes the solid and liquid mixture velocity, Uₛₗᵢₚ denotes the slip velocity of the solid particles, and Uₛₛ denotes the superficial solid velocity. The pressure gradient is calculated by assuming the dispersed flow is homogeneous and by adding the friction loss and gravity together. The approach involving these two terms is the same as the traditional approach to calculate the pressure loss of a single phase flow, except that the single phase density is replaced with the mixture density.

The described modeling may be performed with respect to a flow in a tubular structure at various locations along a length of the structure. Accordingly, parameters including the particle concentration may be simulated/determined at each of the locations. In this manner, measures can be taken to keep the particle concentrations at one or more locations of the structure below a particular value (e.g., a maximum tolerance value).

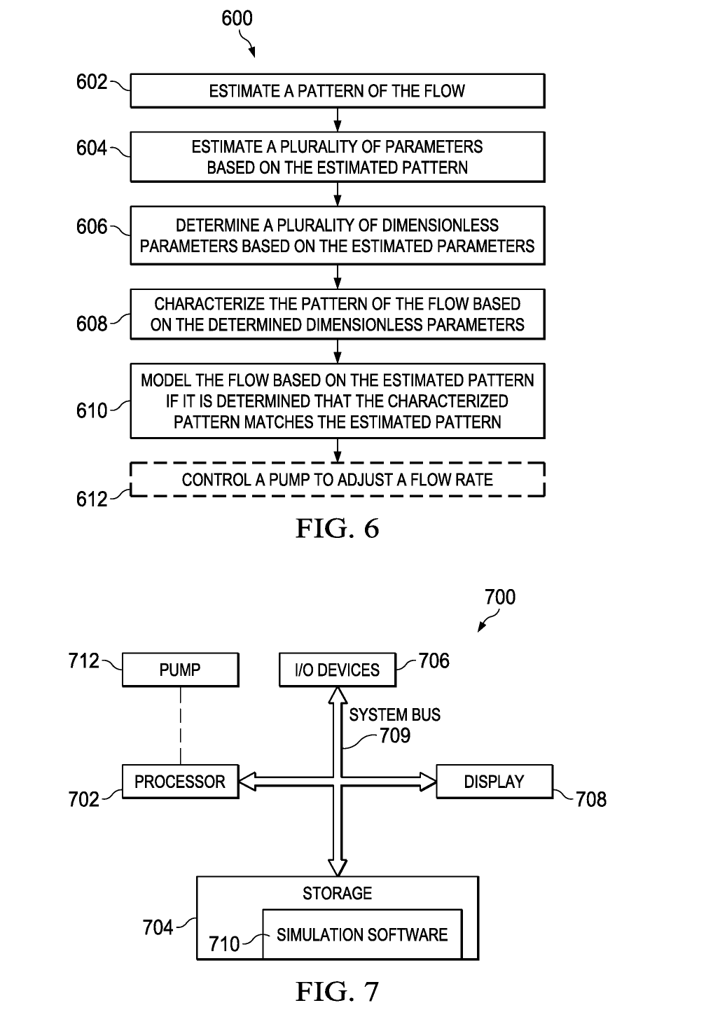

FIG. 6 shows a flowchart of an illustrative method 600 for determining characteristics of a flow of a mixture of particles and a fluid in a tubular structure. At block 602, a pattern of the flow is estimated. For example, the pattern of the flow is estimated as a stationary bed flow, a dispersed flow, or a transitional flow that is relative to the stationary bed flow and the dispersed flow. At block 604, a plurality of parameters are estimated based on the estimated pattern of the flow. For example, these parameters may include a friction velocity, a slip velocity, and a flow velocity. According to a particular embodiment, the parameters are estimated if the estimated pattern is either the stationary bed flow or the transitional flow and it is determined that a re-suspension rate REᵣ and a deposition rate Dᵣ are balanced. At block 606, a plurality of dimensionless parameters are determined based on the estimated plurality of parameters. The dimensionless parameters may include a first dimensionless parameter (e.g., Ωₕ) corresponding to an effect of turbulence on the flow and a second dimensionless parameter (e.g., Ωᵥ) corresponding to an effect of gravity on the flow.

At block 608, the pattern of the flow is characterized as the stationary bed flow, the dispersed flow, or the transitional flow, based on the determined plurality of dimensionless parameters. For example, the dimensionless parameters are applied to a flow pattern map such as map 300. At block 610, the flow is modeled based on the estimated pattern if it is determined that the characterized pattern matches the estimated pattern.

With reference to block 612, the method may further include controlling a pump to adjust a flow rate. For example, modeling the flow may include determining at least a pressure gradient or a concentration of the particles in the flow. In this situation, the pump is controlled to adjust a flow rate of fluid to increase the flow in the tubular structure, if the determined pressure gradient falls below a first threshold and/or the determined concentration rises above a second threshold. As another example, the pump is controlled to adjust a rate of flow input to the tubular structure to obtain the minimum pressure loss for a given rate of particle input to the tubular structure.

It is understood that verifications may be performed whenever the pattern of the flow is characterized (e.g., at blocks 602, 608). For example, if a particular flow can be characterized as both a stationary bed flow and as another type of flow, it may be concluded that a stationary bed (e.g., a stationary bed of a significant thickness) is not present if the angle 9 is smaller in magnitude that a particles critical sliding angle (e.g., the minimum inclination angle of the conduit at which the packed particles stays stationary). As another example, it may be concluded that a dispersed flow (e.g., all the particles are dispersed in the fluid) is present if the angle 9 is smaller in magnitude that a particles critical deposition angle (e.g., the maximum angle at which the particles can pack in the conduit). In such situations, it may be concluded that the flow likely is not a stationary bed flow.

FIG. 7 is a simplified block diagram of a computer system 700 adapted for determining characteristics of a flow of particles and fluid mixture in a tubular structure. With reference to FIG. 7, the computer system 700 includes at least one processor 702, a non-transitory, computer-readable storage 704, I/O devices 706, and an optional display 708, all interconnected via a system bus 709. Software instructions executable by the processor 702 for implementing a determination/modeling system in accordance with embodiments described herein, may be stored in storage 704. Although not explicitly shown in FIG. 7, it will be recognized that the computer system 700 may be connected to one or more public and/or private networks via appropriate network connections. Further, one or more elements of the computer system 700 (e.g., the processor 702) may be coupled (e.g., wirelessly coupled) to a pump 712 such that the computer system can control the pump to adjust a flow rate to a tubular structure. It will also be recognized that the software instructions 710 for implementing the determination/modeling system may be loaded into storage 704 from a CD-ROM or other appropriate storage media.

Embodiments disclosed herein include:

A: A computing system that includes a processor that estimates a pattern of a flow of a mixture of particles and a fluid in a tubular structure as a stationary bed flow, a dispersed flow, or a transitional flow that is relative to the stationary bed flow and the dispersed flow. The processor estimates a plurality of parameters based on the estimated pattern of the flow. The processor determines a plurality of dimensionless parameters, based on the estimated plurality of parameters. The dimensionless parameters include a first dimensionless parameter corresponding to an effect of turbulence on the flow and a second dimensionless parameter corresponding to an effect of gravity on the flow. The processor characterizes the pattern of the flow as the stationary bed flow, the dispersed flow, or the transitional flow, based on the determined plurality of dimensionless parameters. The processor models the flow based on the estimated pattern if it is determined that the characterized pattern matches the estimated pattern.

B. A method for determining characteristics of a flow of mixture of particles and fluid in a tubular structure a method that includes estimating a pattern of the flow as a stationary bed flow, a dispersed flow, or a transitional flow that is relative to the stationary bed flow and the dispersed flow. The method further includes estimating a plurality of parameters based on the estimated pattern of the flow. The method further includes determining a plurality of dimensionless parameters, based on the estimated plurality of parameters. The dimensionless parameters include a first dimensionless parameter corresponding to an effect of turbulence on the flow and a second dimensionless parameter corresponding to an effect of gravity on the flow. The method further includes characterizing the pattern of the flow as the stationary bed flow, the dispersed flow, or the transitional flow, based on the determined plurality of dimensionless parameters, and modeling the flow based on the estimated pattern if it is determined that the characterized pattern matches the estimated pattern.

Each of the embodiments, A and B, may have one or more of the following additional elements in any combination.

Element 1: wherein the processor models the flow based on the estimated pattern by determining at least a pressure gradient or a concentration of the particles in the flow, and wherein the processor further controls a pump coupled to the computing system, to adjust a flow rate of fluid to increase the flow in the tubular structure, if at least the determined pressure gradient falls below a first threshold or the determined concentration rises above a second threshold. Element 2: wherein, if the estimated pattern is the stationary bed flow or the transitional flow, the processor further: determines a deposition rate and a re-suspension rate of the particles in the tubular structure based on the estimated plurality of parameters; wherein the processor determines the plurality of dimensionless parameters by determining the first dimensionless parameter and the second dimensionless parameter based on the estimated plurality of parameters if it is determined that the deposition rate and the re-suspension rate are balanced. Element 3: wherein, if the estimated pattern is the stationary bed flow or the transitional flow, the processor further: determines a deposition rate and a re-suspension rate of the particles in the tubular structure based on the estimated plurality of parameters; and re-estimates the pattern of the flow as a pattern other than the estimated pattern if it is determined that the deposition rate and the re-suspension rate are not balanced. Element 4: wherein the plurality of dimensionless parameters are not determined directly from at least a particle shape, a particle size, or a size of the tubular structure. Element 5: wherein the plurality of dimensionless parameters are determined without knowledge or assumption of at least a particle shape, a particle size, or a size of the tubular structure. Element 6: wherein the tubular structure comprises a pipe. Element 7: wherein the processor further controls a pump coupled to the computing system, to adjust a rate of flow input to the tubular structure to obtain the minimum pressure loss for a given rate of particle input to the tubular structure. Element 8: wherein the value of the first dimensionless parameter is determined based on an expression:

$$\frac{{u}^{*}}{{u}_{settling} \cdot sin θ} ,$$

and
wherein u* denotes a friction velocity of the flow, u_{settling} denotes a settling velocity of the particles, and θ denotes an angle at which the wellbore extends with respect to the direction of gravity. Element 9: wherein the value of the second dimensionless parameter is determined based on an expression:

$$\frac{{u}_{f}}{{u}_{settling} \cdot sin θ} ,$$

and
wherein u_{f} denotes a fluid velocity of the flow.

Element 10: wherein modeling the flow based on the estimated pattern comprises determining at least a pressure gradient or a concentration of the particles in the flow, and wherein the method further comprises controlling a pump to adjust a flow rate of fluid to increase the flow in the tubular structure, if at least the determined pressure gradient falls below a first threshold or the determined concentration rises above a second threshold. Element 11: wherein, if the estimated pattern is the stationary bed flow or the transitional flow, the method further comprises: determining a deposition rate and a re-suspension rate of the particles in the tubular structure based on the estimated plurality of parameters; wherein determining the plurality of dimensionless parameters comprises determining the first dimensionless parameter and the second dimensionless parameter based on the estimated plurality of parameters if it is determined that the deposition rate and the re-suspension rate are balanced. Element 12: wherein, if the estimated pattern is the stationary bed flow or the transitional flow, the method further comprises: determining a deposition rate and a re-suspension rate of the particles in the tubular structure based on the estimated plurality of parameters; and re-estimating the pattern of the flow as a pattern other than the estimated pattern if it is determined that the deposition rate and the re-suspension rate are not balanced. Element 13: wherein the plurality of dimensionless parameters are not determined directly from at least a particle shape, a particle size, or a size of the tubular structure. Element 14: wherein the plurality of dimensionless parameters are determined without knowledge or assumption of at least a particle shape, a particle size, or a size of the tubular structure. Element 15: wherein the tubular structure comprises a pipe. Element 16: further comprising controlling a pump to adjust a rate of flow input to the tubular structure to obtain the minimum pressure loss for a given rate of particle input to the tubular structure. Element 17: wherein the value of the first dimensionless parameter is determined based on an expression:

$$\frac{{u}^{*}}{{u}_{settling} \cdot sin θ} ,$$

and
wherein u* denotes a friction velocity of the flow, u_{settling} denotes a settling velocity of the particles, and θ denotes an angle at which the wellbore extends with respect to the direction of gravity. Element 18: wherein the value of the second dimensionless parameter is determined based on an expression:

$$\frac{{u}_{f}}{{u}_{settling} \cdot sin θ} ,$$

and
wherein u_{f} denotes a fluid velocity of the flow.

Numerous variations and modifications will become apparent to those skilled in the art once the above disclosure is fully appreciated. The methods and systems can be used for determining characteristics of a flow of particles and fluid mixture in a tubular structure such as a pipe). However, it is understood that the disclosed methods and systems can be used for flows in structures of other shapes and forms. The ensuing claims are intended to cover such variations where applicable.

What is claimed is:

1. A method of determining characteristics of a flow of a mixture of particles and a fluid in a tubular structure, comprising:
estimating a pattern of the flow as a stationary bed flow, a dispersed flow, or a transitional flow that is relative to the stationary bed flow and the dispersed flow;
estimating a plurality of parameters based on the estimated pattern of the flow;
determining a plurality of dimensionless parameters comprising a first dimensionless parameter corresponding to an effect of turbulence on the flow and a second dimensionless parameter corresponding to an effect of gravity on the flow, based on the estimated plurality of parameters;
characterizing the pattern of the flow as the stationary bed flow, the dispersed flow, or the transitional flow, based on the determined plurality of dimensionless parameters; and
modeling the flow based on the estimated pattern if it is determined that the characterized pattern matches the estimated pattern.

2. The method of claim 1,
wherein modeling the flow based on the estimated pattern comprises determining at least a pressure gradient or a concentration of the particles in the flow, and
wherein the method further comprises controlling a pump to adjust a flow rate of fluid to increase the flow in the tubular structure, if at least the determined pressure gradient falls below a first threshold or the determined concentration rises above a second threshold.

3. The method of claim 1, wherein, if the estimated pattern is the stationary bed flow or the transitional flow, the method further comprises:
determining a deposition rate and a re-suspension rate of the particles in the tubular structure based on the estimated plurality of parameters;
wherein determining the plurality of dimensionless parameters comprises determining the first dimensionless parameter and the second dimensionless parameter based on the estimated plurality of parameters if it is determined that the deposition rate and the re-suspension rate are balanced.

4. The method of claim 1, wherein, if the estimated pattern is the stationary bed flow or the transitional flow, the method further comprises:
determining a deposition rate and a re-suspension rate of the particles in the tubular structure based on the estimated plurality of parameters; and
re-estimating the pattern of the flow as a pattern other than the estimated pattern if it is determined that the deposition rate and the re-suspension rate are not balanced.

5. The method of claim 1, wherein the plurality of dimensionless parameters are not determined directly from at least a particle shape, a particle size, or a size of the tubular structure.

6. The method of claim 1, wherein the plurality of dimensionless parameters are determined without knowledge or assumption of at least a particle shape, a particle size, or a size of the tubular structure.

7. The method of claim 1, wherein the tubular structure comprises a pipe.

8. The method of claim 1, further comprising controlling a pump to adjust a rate of flow input to the tubular structure to obtain the minimum pressure loss for a given rate of particle input to the tubular structure.

9. The method of claim 1,
wherein the value of the first dimensionless parameter is determined based on an expression:
$$\frac{{u}^{*}}{{u}_{settling} \cdot sin θ} ,$$
and
wherein u* denotes a friction velocity of the flow, u_{settling} denotes a settling velocity of the particles, and θ denotes an angle at which the wellbore extends with respect to the direction of gravity.

10. The method of claim 9,
wherein the value of the second dimensionless parameter is determined based on an expression:
$$\frac{{u}_{f}}{{u}_{settling} \cdot sin θ} ,$$
and
wherein u_{f} denotes a fluid velocity of the flow.

11. A computing system comprising:
a processor that:
estimates a pattern of a flow of a mixture of particles and a fluid in a tubular structure as a stationary bed flow, a dispersed flow, or a transitional flow that is relative to the stationary bed flow and the dispersed flow;
estimates a plurality of parameters based on the estimated pattern of the flow;
determines a plurality of dimensionless parameters comprising a first dimensionless parameter corresponding to an effect of turbulence on the flow and a second dimensionless parameter corresponding to an effect of gravity on the flow, based on the estimated plurality of parameters;
characterizes the pattern of the flow as the stationary bed flow, the dispersed flow, or the transitional flow, based on the determined plurality of dimensionless parameters; and
models the flow based on the estimated pattern if it is determined that the characterized pattern matches the estimated pattern.

12. The computing system of claim 11,
wherein the processor models the flow based on the estimated pattern by determining at least a pressure gradient or a concentration of the particles in the flow, and
wherein the processor further controls a pump coupled to the computing system, to adjust a flow rate of fluid to increase the flow in the tubular structure, if at least the determined pressure gradient falls below a first threshold or the determined concentration rises above a second threshold.

13. The computing system of claim 11, wherein, if the estimated pattern is the stationary bed flow or the transitional flow, the processor further:
determines a deposition rate and a re-suspension rate of the particles in the tubular structure based on the estimated plurality of parameters;
wherein the processor determines the plurality of dimensionless parameters by determining the first dimensionless parameter and the second dimensionless parameter based on the estimated plurality of parameters if it is determined that the deposition rate and the re-suspension rate are balanced.

14. The computing system of claim 11, wherein, if the estimated pattern is the stationary bed flow or the transitional flow, the processor further:
determines a deposition rate and a re-suspension rate of the particles in the tubular structure based on the estimated plurality of parameters; and
re-estimates the pattern of the flow as a pattern other than the estimated pattern if it is determined that the deposition rate and the re-suspension rate are not balanced.

15. The computing system of claim 11, wherein the plurality of dimensionless parameters are not determined directly from at least a particle shape, a particle size, or a size of the tubular structure.

16. The computing system of claim 11, wherein the plurality of dimensionless parameters are determined without knowledge or assumption of at least a particle shape, a particle size, or a size of the tubular structure.

17. The computing system of claim 11, wherein the tubular structure comprises a pipe.

18. The computing system of claim 11, wherein the processor further controls a pump coupled to the computing system, to adjust a rate of flow input to the tubular structure to obtain the minimum pressure loss for a given rate of particle input to the tubular structure.

19. The computing system of claim 11,
wherein the value of the first dimensionless parameter is determined based on an expression:
$$\frac{{u}^{*}}{{u}_{settling} \cdot sin θ} ,$$
and
wherein u* denotes a friction velocity of the flow, u_{settling} denotes a settling velocity of the particles, and θ denotes an angle at which the wellbore extends with respect to the direction of gravity.

20. The computing system of claim 19,
wherein the value of the second dimensionless parameter is determined based on an expression:
$$\frac{{u}_{f}}{{u}_{settling} \cdot sin θ} ,$$
and
wherein u_{f} denotes a fluid velocity of the flow.
